(19) United States
(12) Patent Application Publication
(10) Pub. No.: US 2023/0338943 A1
(43) Pub. Date: Oct. 26, 2023

(54) SAMPLE CARRIER

(71) Applicant: ibidi GmbH, Gräfelfing (DE)

(72) Inventors: Zeno von Guttenberg, Gröbenzell (DE); Julia Schirmer, Grafing (DE)

(21) Appl. No.: 18/295,431

(22) Filed: Apr. 4, 2023

(30) Foreign Application Priority Data
Apr. 26, 2022 (EP) 22 169 988.7

(51) Int. Cl. B01L 3/00

(52) U.S. Cl. CPC B01L 3/502; B01L 2200/12; B01L 2300/042

(57) ABSTRACT

The invention relates to a sample carrier comprising a reservoir with a bottom, and two channels each having an opening into the reservoir, wherein the two openings are arranged above the bottom, wherein an underside of the sample carrier is formed flat, and wherein each of the two openings faces in a direction that is not parallel to the underside.

### CROSS-REFERENCE TO RELATED APPLICATION

This application claims the benefit of priority under 35 U.S.C. § 119(a) to European Patent Application No. 22 169 988.7, filed Apr. 26, 2022. The entire content of this application is hereby incorporated by reference herein.

### FIELD OF THE INVENTION

The present invention relates to a sample carrier and a method for forming a channel structure in a hydrogel in such a sample carrier.

### BACKGROUND

A channel structure in a hydrogel may be formed in a sample carrier by introducing a sacrificial structure into a reservoir of the sample carrier, which is subsequently enveloped by hydrogel. Finally, the sacrificial structure is rinsed out. The connections for the sacrificial structure are formed in a side wall of the reservoir. Such a sample carrier is known from the scientific publication “Renal absorption in 3D vascularized proximal tubule models”, Lin et. al, PNAS 116, p. 5399-5404 (2019). One problem with this embodiment is that the sacrificial structure is difficult to introduce into these lateral openings, especially not by means of 3D printing or any other automated method in which the sacrificial structure is introduced into the reservoir from a top side. This may result in unclean connections of the channel structure in the hydrogel after the sacrificial structure has been rinsed out, or the contacting may fail altogether because the channel structure is interrupted at the connections. Another disadvantage of the cited sample carrier is that the sacrificial structure is applied directly onto the bottom of the reservoir instead of being surrounded all around by hydrogel. However, this structure is non-physiological and does not correspond to the structures that occur in nature, for example inside organs that are actually to be studied.

A fluid channel system comprising a chamber filled with a polymerised hydrogel is disclosed in EP 3 020 480 A1. From EP 1 880 764 A1 a sample carrier comprising a substrate with a reservoir having a bottom is known, wherein the reservoir is filled to a predetermined height with a carrier material for cell growth. EP 1 480 749 A2 teaches a microfluid system with a flow-through volume that opens into a fluid reservoir.

### SUMMARY OF THE INVENTION

In light of these disadvantages, it is the object of the present invention to provide a sample carrier and an associated method for forming a channel structure in a hydrogel to enable improved formation of connections of a channel structure to channels formed in the sample carrier. This object is solved by the sample carrier according to claim 1 and the method according to claim 12. Particularly advantageous embodiments can be found in the corresponding dependent claims.

According to the invention, a sample carrier comprising a reservoir with a bottom and two channels each having an opening into the reservoir is provided, wherein the two openings are arranged above the bottom, wherein an underside of the sample carrier is formed flat, and wherein each of the two openings faces in a direction that is not parallel to the underside.

Due to the openings in the reservoir facing in a direction that is not parallel to the underside, a sacrificial structure for a channel structure can be applied from the outside so that the sacrificial structure is contacted at the openings in a proper way. The specific orientation of the openings enables applying the structure to the openings in a proper way and ensuring an improved formation of connections of the sacrificial structure to the channels formed in the sample carrier.

The flat underside is used in the following as a reference surface for describing the further properties of the sample carrier. A side of the sample carrier opposite the underside is referred to as its upper side in the following. In the intended use of the sample carrier, the underside forms the underside of the sample carrier on which it can rest.

Unless otherwise specified, in the following all indications that refer directly or indirectly to the sample carrier and the spatial arrangement of its components, i.e. for example “above”, “below”, are to be understood with reference to the underside of the sample carrier. An element located between the underside and the upper side is thus located above the underside.

Different embodiments are possible for the reservoir. For example, it may be formed as a recess in the sample carrier. The sample carrier may be provided with a flat upper side. The reservoir may be arranged on this flat upper side in the form of a pot. A cross-sectional shape of the reservoir, wherein the cut is made parallel to the underside, may also be formed in different ways, for example circular or polygonal, in particular rectangular or hexagonal. The bottom of the reservoir may be flat. In particular, the bottom of the reservoir may be parallel to the underside of the sample carrier.

For example, a channel refers to a cavity provided in the sample carrier. Alternatively, a channel may also have the form of a trench or a groove-like depression in a surface of the sample carrier. Similarly, a channel may comprise both of the above embodiments, being formed partially as a cavity in the sample carrier and partially as a trench on a surface of the sample carrier. Typically, a channel comprises two apertures or openings. One of these aperture of each channel is formed as an opening inside the reservoir and above the bottom.

One or both channels may have a diameter, or a width of a cross-section, smaller than the length of the channel or channels. The length may be the distance between the two openings of a channel, wherein to determine the length of a channel one passes through it from its first opening to its second opening. The ratio between the width of a cross-section and the length of a channel may have a value of 0.2 or less, in particular 0.1 or less, in particular 0.05 or less. A reservoir, on the other hand, may have a diameter or width of a cross-section that is greater than the height of the reservoir. The height of the reservoir refers to the vertical distance between the bottom of the reservoir and the upper side of the sample carrier. The ratio between the width of the cross-section and the height of the reservoir may have a value of 2 or more, in particular 5 or more, in particular 10 or more.

Each of the openings is formed in such a way that it faces in a direction that is not parallel to the underside. At the same time, the opening may face in a direction that is tilted in relation to the underside. The opening forms an opening plane. A normal vector may be defined for this opening plane, which is perpendicular to the opening plane. In the same way, a normal vector may be defined for the underside. The normal vector of the opening plane is not perpendicular to the normal vector of the underside of the sample carrier. For example, the normal vector of the opening plane and the normal vector of the underside include an angle greater than or equal to 0° and less than 90°. In particular, this angle has a value between 0° and 45°, in particular between 0° and 30°. Alternatively, the angle between the direction in which each of the two openings faces and the underside may have a value greater than 0° and less than or equal to 90°, in particular a value between 45° and 90°, in particular between 60° and 90°.

The reservoir of the sample carrier may have a side wall comprising a surface region which is not perpendicular to the underside, one or both of the openings being located in the surface region.

An opening located in the surface area is more easily accessible, especially from above, than an opening located directly in the side wall. This allows easy introducing a substance, for example a sacrificial structure, into the openings. Thus, for example, it is possible to introduce the substance into the openings from above using a needle as from a 3D printer or a comparable filling device. This also ensures that, in the case of machine filling of the openings, these are filled in a proper way in order to finally produce a proper contact of a channel structure to the openings.

This surface area may be formed in such a way that a cross-sectional area of the reservoir remains the same or increases starting from the bottom. The surface area may have a surface that is not perpendicular to the underside of the sample carrier. In particular, the angle between the underside of the sample carrier and the surface of the surface area may be greater than or equal to 0° and less than 90°. In particular, this angle may have a value between 0° and 45°, in particular between 0° and 30°.

The surface area may be formed circumferentially, i.e. along the entire inner circumference of the reservoir on the side wall of the reservoir. The surface area may also be provided only along a section on the side wall. Alternatively, there may be several surface areas that are formed as individual, separated sections. A single surface area may be provided for each of the openings, and the relative arrangement of the surface areas is not limited. Likewise, both openings may be formed in a common surface area and/or there may be individual surface areas in which no opening is formed.

Due to the freely selectable configuration and arrangement of the surface area as well as the openings formed in it, a variety of structures can finally be introduced into the reservoir. The sample carrier can thus be flexibly formed and used for different applications and simulations.

Furthermore, the surface area may have the form of a step, wherein the surface area is arranged parallel to the underside of the sample carrier.

The arrangement of the openings in a surface area that is parallel to the underside is particularly advantageous in connection with the aforementioned filling of the openings with a substance such as a sacrificial structure. For example, a needle of a filling device for said substance can be introduced directly into the reservoir from above so that the substance can be optimally applied to the openings and they are optimally covered with the substance.

A step can be understood in particular as a structure that has a surface parallel to the underside of the sample carrier as well as an edge. Thus, the openings that may be provided in this surface area face in this case in a direction perpendicular to the underside, or the normal vector of the opening plane is parallel to the normal vector of the underside. The openings may face the upper side of the sample carrier.

The side wall of the reservoir may be configured in such a way that it is provided with a section that is perpendicular to the underside. The step may be adjacent to the perpendicular section of the side wall so that there is a right angle between the perpendicular section of the side wall and the surface area or step. Also, the surface area may be provided with another rectangular edge facing a vertical centre axis of the reservoir.

One of the two channels of the sample carrier may have a second end in the form of a hole on an upper side of the sample carrier opposite the underside.

In the intended use of the sample carrier, such an arrangement of the connections on the upper side of the sample carrier simplifies the filling of the channels, because an access from above is usually associated with the fewest spatial restrictions. In particular, machine filling, in which a needle or other filling device projects from the top of the sample carrier, is thus made particularly easy. Likewise, the connections and the openings may be filled with the same device and/or technique.

It is also conceivable that both channels are provided with a second end as a hole or opening on the upper side of the sample carrier. It is also possible that the sample carrier comprises more than one reservoir. In this case, a channel may be formed in such a way that it connects the two reservoirs and thus is not provided with an end at the upper side of the sample carrier. Furthermore, the channels may extend at least partially perpendicularly through the sample carrier starting from the respective hole in the upper side.

The sample carrier may comprise a cover element and a bottom element, wherein the cover element and the bottom element are connected to each other over the complete area, wherein the underside of the sample carrier is disposed on the bottom element, wherein at least one of the channels is at least partially formed as a trench on an underside of the cover element and wherein the trench is covered by the bottom element.

The additional use of a bottom element simplifies the production of the sample carrier. For example, the cover element may be manufactured by injection moulding, which is a simple, precise and cost-effective manufacturing method. While injection moulding cannot be used to form cavities in a component to be manufactured, forming a trench on a surface covered with the bottom element is a simple alternative to obtain an equivalent sample carrier.

In this case, the entire sample carrier may thus consist of two elements, the bottom element and a cover element. In particular, the reservoir with a bottom and the two channels may be arranged in the cover element. The properties of the sample carrier mentioned so far may thus also apply to the cover element.

The sample carrier may also be configured in such a way that the reservoir is formed as a through hole in the cover element and the bottom of the reservoir is formed by the bottom element.

The channels provided in the sample carrier may be formed as described above as a cavity in the sample carrier, in particular in the cover element, or as a trench on an underside of the cover element. Both types may also be present together in one specimen support, for example when a channel is provided at least partially as a cavity within the sample carrier support, in the cover element, and at least partially as a trench on a surface of the sample carrier, in particular the underside of the cover element, the trench being covered by the bottom element. In this context, a cover is in particular a non leaking closure of the trench by the bottom element. This allows fluids to flow through the channel without leaving the channel at positions other than the channel ends.

One or both channels may extend from the openings at least partially perpendicular to the underside through the sample carrier.

This alignment of the channels represents a further contribution to a simple and efficient production of a sample carrier, especially when the cover element is produced by injection moulding. In particular, injection moulding allows a comparatively easy way to form elements extending horizontally and/or vertically to a base surface, whereas elements extending diagonally or otherwise are difficult or impossible to form. Therefore, the configuration of partially vertical channels, especially in combination with sections in the form of trenches, is advantageous for injection moulding processes.

One or both of the channels provided in the sample carrier may consist of sections that are parallel or perpendicular to the underside. In particular, the trenches may form the parallel sections and vertical sections may extend perpendicular to the underside of the sample carrier as through holes through the cover element.

Furthermore, one or both of the openings of the channels of the upper side of the sample carrier may be provided with a connector. These connectors at the ends of the channels in the surface of the sample carrier may be have a conical form. In particular, the connectors may conform to the Luer standard, wherein the connectors may be provided with a female Luer or Luer lock adapter. In intended use, a device for filling the channels through the connectors may then be provided with a male Luer or Luer lock adapter.

By using conical connectors, especially connectors that conform to the Luer standard, the connectors may be connected in a non leaking manner during filling, and filling can thus be carried out easily and reliably. In addition, the sample carrier is compatible with most devices for filling, as the Luer standard is widely used in this context.

The cover element may be a plastic support. In particular, it may comprise plastics such as COC (cyclo-olefin copolymer), COP (cyclo-olefin polymer), PC (polycarbonate), PS (polystyrene), PE (polyethylene), PMMA (polymethymethacrylate) or a transparent thermoplastic or elastomer. In particular, the cover element may have been produced by injection moulding. However, the cover element according to this description is not limited to the materials and manufacturing processes mentioned.

By using the materials and processes mentioned, the sample carriers can be produced cost-effectively and in large quantities with consistent quality. This is due to the fact that injection moulding with plastics is an established and reliable process and is particularly applicable in the case of the plastics mentioned. The use of a transparent plastic is particularly advantageous in order to enable carrying out optical examinations in the sample carrier, for example via microscopy.

The bottom element may comprise plastic and/or glass. The plastics used may be COC, COP, PC, PS, PE, PMMA or other transparent plastics, especially thermoplastics. In particular, the bottom element may also have the form of a film. In this case, the bottom element may comprise a material having the birefringence and autofluorescence of a Schott cover glass (such as D 263 M Schott Glas, No. 1.5H (170+/−5 μm)).

Such a plastic with a high optical quality may enable microscopy examinations with high precision and low optical imperfections, especially when using microscopy. For example, inverted microscopy may be performed on the sample carrier. A lens is facing to the sample carrier from below and the examination is carried out through the underside of the sample carrier. In this case, the high optical quality of the bottom element is advantageous for obtaining images with high resolution and low aberration.

The bottom element may be attached to the cover element by welding, such as ultrasonic welding, solvent welding or heat welding. The bottom element may also be attached to the cover element by gluing. In particular, dispersion adhesives or double-sided adhesive tapes may be used in this case.

The bottom element is attached to the cover element in such a way that the optical properties of the sample carrier are maintained and, for example, microscopy, in particular fluorescence microscopy or inverted microscopy, may be carried out with the sample carrier. At the same time, these processes are well established in the area of plastic components and represent a cost-effective and efficient way of reliably attaching the bottom element to the cover element.

The cover element may have a thickness of 0.5 mm to 2 cm, in particular 0.5 mm to 5 mm. The thickness is the distance between the upper side and the underside of the cover element. The bottom element may have a thickness between 1 μm and 2 mm, in particular between 1 μm and 300 μm. An analogous definition is to be applied for the thickness of the bottom element.

In particular, the bottom element may be provided as a film that is attached to the cover element. A small thickness of the base element provides the advantage that the objective can be brought particularly close to an area to be observed in the sample carrier in the case of inverted microscopy. This allows for improved optical resolution.

The sample carrier may have at least one further channel, the so-called supply channel, wherein one end of the supply channel opens into the reservoir in a supply opening and wherein the supply opening is provided at a height of one of the two openings or above both openings.

The at least one supply channel increases the flexibility and the area of application of the described sample carrier. For example, other substances or materials may be fed into the reservoir through this supply channel than through the other existing channels. This specific advantage will be explained in more detail in the description of the corresponding method.

The sample carrier may comprise one or more supply channels. The properties mentioned with regard to a supply channel may apply to one, several or all supply channels.

When referring to the height of an element in the following, it means the vertical distance between the underside of the sample carrier and the element. In particular, the height of an opening is the vertical distance between the underside of the sample carrier and the opening.

Like the other channels, this supply channel may be at least partially formed as a cavity within the sample carrier and/or as a trench on a surface of the sample carrier. No further restrictions exist with regard to a direction in which the supply opening which is provided in the reservoir points.

For example, the supply opening may be provided directly in a side wall. If the side wall is perpendicular to the underside of the sample carrier, the supply opening would in this case face in a direction parallel to the underside. It is also possible that a surface area, similar to the case of the openings, is formed in a way in which the supply opening is disposed. The supply opening may be disposed at the height of one of the openings or above both openings. In particular, the supply opening may also be provided in a surface area in which one or more openings are disposed. If the surface area is formed in the form of a step, the supply opening may be provided in particular in the upper side of the step.

The supply channel may be at least partially formed as a trench on the lower side of the cover element. The supply channel may also extend at least partially perpendicularly through the sample carrier.

Like the other channels, the supply channel may have a further opening, the so-called supply opening, in a surface of the sample carrier, in particular in its upper side. Furthermore, this opening may be provided with a connector. This connector may have a conical form and/or conform to the Luer standard.

The supply channel may consist of individual sections that are parallel or perpendicular to the underside of the sample carrier.

The sample carrier may comprise a supply opening which is arranged at a point in the side wall of the reservoir at which an edge is formed and/or at which the radius of curvature of the side wall has a local minimum.

A side wall of the reservoir in which an edge or a point with a minimum radius of curvature provided with a supply opening is provided is advantageous for the intended use of the sample carrier. When filling the reservoir through the channel with a hydrogel, air bubbles may be generated which can lead to undesirable side effects in the final sample carrier, as explained in relation to the method according to the invention. A point with a minimum radius of curvature makes it easier to extract these air bubbles. This circumstance is explained in more detail in the detailed description of the corresponding method.

An edge disposed in the side wall may be accomplished in particular by the reservoir having a cross-sectional area in the form of a polygon, especially a rectangle or hexagon. The supply opening may be disposed directly at such an edge in the side wall of the reservoir. If there is more than one edge, the supply opening may be disposed on any of the edges. As described, there may also be several supply channels, so that there may also be several supply openings in the reservoir. In this case, the plurality of supply openings may be located at more than one of the existing edges in the side wall or the plurality of supply openings may be located together at one of the edges.

The reservoir does not necessarily have to be provided with an edge in the side wall. Instead, a point may be formed in the side wall that has a minimum radius of curvature. Here, the radius of curvature denotes the radius of a circle that is applied to the relevant point in the side wall and touches the point of the side wall on the inside. There are numerous possibilities to realise such a point with a minimal radius of curvature. For example, the reservoir may have a recess in the side wall. This recess may in particular have the form of a hemisphere of a truncated cone, a truncated pyramid or the like.

In particular, the supply opening may be disposed in a narrow extension of the reservoir, especially at one end of the extension, wherein the supply opening may be arranged in the surface area. In this case, starting from the basic shape of the reservoir in which a surface area is provided, for example a square or a hexagon, an elongated recess is disposed on at least one of the edges of the reservoir. An underside of this recess may be at the same height as the surface area. An elongated recess is understood to be a space whose length is greater than its width. The supply opening may then be disposed in an upper side of the recess. Because the recess has a greater length than width, the radius of curvature at this point can be considered minimal.

Furthermore, the sample carrier may comprise a closure element that closes the reservoir to the outside.

This closure element may form a cover surface of the reservoir.

By closing the reservoir, the sample carrier may be examined from the upper side as well as from the underside; for example, microscopy may be performed on the sample carrier from the upper side and the underside. The sample carrier may thus be used flexibly for various applications.

For example, the reservoir may be closed with a closure element. In particular, the closure element may have the same or similar properties in terms of material and thickness as the bottom element. Likewise, the same requirements apply to the closure element as to the bottom element, which means, for example, that the same optical properties are fulfilled. In particular, the closure element may comprise plastic or glass, wherein plastic includes COC, COP, PC, PS, PE, PMMA or another transparent plastic. The material may have the birefringence and autofluorescence of a Schott cover glass (such as D 263 M Schott Glas, No. 1.5H (170+/−5 μm)). The closure element may also have a thickness of from 1 μm to 1 cm, in particular from 1 μm to 300 μm. In particular, the closure element may also be a film.

The same techniques may be used to close the reservoir with the closure element as for attaching the bottom element to the cover element. These are, for example, welding, including ultrasonic welding, solvent welding or heat welding. Likewise, the closure element and the cover element may be glued together using dispensable adhesives or double-sided adhesive tapes. Because the same techniques can be used as for the bottom element, this high flexibility is not or only slightly associated with increased effort or additional costs.

In a sample carrier, the reservoir may be filled with a hydrogel, wherein the openings are not covered with the hydrogel.

By providing such a sample carrier, a user of the sample carrier is free to determine the appropriate use. For example, he may create a channel structure in the hydrogel at will that is optimised for a corresponding application.

The reservoir may be filled with hydrogel up to the height of one or both openings so that the openings in the reservoir are not covered with hydrogel. For example, the hydrogel may only be filled up to the height of the lower of the two openings. It may also be that the surface of the hydrogel is not even or parallel to the underside of the sample carrier. This includes in particular the possibility that the filling level of the hydrogel is not constant with respect to the bottom of the reservoir, but that the filling level decreases from the higher opening to the lower opening.

The hydrogel corresponds to a gel of cross-linked polymers that can bind water. It may comprise or consist of the materials gelMA, alginate, collagen or fibrin. When choosing the material, it is important to take into account that it must be able to gel appropriately in order to form a gel. Collagen can be cross-linked by thermal influence, for example. In contrast, alginate can be cross-linked chemically, whereas with GeIMA cross-linking can be achieved by UV radiation. In the case of fibrin, a gel can be produced enzymatically by thrombin. In particular, those materials are appropriate that meet the requirements for the corresponding application, especially sufficient stability, for example for the physiological simulation of transport processes in a liver or a kidney.

In the case of the sample carriers described above, a channel structure may also be provided in the hydrogel which connects the openings with each other.

A sample carrier with a reservoir filled with hydrogel and a channel structure provided therein may be used, for example, for the physiological simulation of processes in human organs. In particular, channels with a round or approximately round cross-section can be created that most closely resembles a channel system found in nature. In contrast, the channel structure would have a flattened or significantly flattened cross-sectional area, for example, if it were formed directly on the bottom of the reservoir.

A channel structure is a cavity that has a opening on at least two sides and connects these openings to each other. In the reservoir of the sample carrier, these ends of the channel structure are connected to the openings. The channels may extend in a rectilinear way or be provided with a single or multiple curvature. Also, the channels of the channel structure may branch or reconnect.

The channel structure is also not limited to one plane, but may be formed three-dimensionally within the hydrogel.

The reservoir may be completely filled with hydrogel or up to a height above the openings so that the sacrificial structure is surrounded by or at least embedded in hydrogel.

The present invention further includes a method for forming a channel structure in a hydrogel.

The method comprises the following steps:
providing a sample carrier as described above;
filling the reservoir of the sample carrier with the hydrogel so that the openings are not covered with the hydrogel;
applying a sacrificial structure onto the filled hydrogel so that the openings are completely covered by the sacrificial structure and the openings are connected by the sacrificial structure;
further filling the reservoir with hydrogel so that the sacrificial structure is partially or completely enclosed by the hydrogel; and
rinsing out the sacrificial structure so that the channel structure connecting the openings forms in the hydrogel.

After completely carrying out the described method, a sample carrier is obtained in whose reservoir a channel structure is formed in a hydrogel. The method in combination with the described sample carrier offers several advantages. First, it is possible to build a channel structure that is partially or completely enclosed by hydrogel; the sacrificial structure is thus embedded in the hydrogel. Thus, the side walls of the channel structure are built by hydrogel. This is a more physiological configuration than if the channel structure is at least partially closed off by a surface of the sample carrier, because the channel structure is provided with a physiological rigidity in this way. For example, if the sacrificial structure were applied directly to the bottom of the reservoir, the side walls of the channel structure would be partially built by the material of the cover element or bottom element. This is harder than the hydrogel and represents a non-physiological structure for cells within the channel structure.

Furthermore, depending on the form of the applied sacrificial structure, different cross-sectional shapes of the channel structure may be realised. Furthermore, it is possible to fill in hydrogel without closing or at least partially blocking the openings of the channels. This allows improved connections of the channel structure to the openings and to the channels created in the sample carrier. This is an important prerequisite for proper contacting the channel structure at the openings finally and for a flow of a fluid through the channels disposed in the sample carrier and the channel structure disposed in the hydrogel. The openings are fluidly connected by the channel structure. All these factors together contribute to an improved formation of a channel structure in a hydrogel.

Filling the reservoir may be accomplished, for example, by filling the hydrogel from above with a filling device. The hydrogel is filled up to the height of the openings so that the openings themselves are not covered with the hydrogel. If the openings are not provided at the same height with respect to the underside of the sample carrier, the hydrogel can be filled up to the height of the lower opening. Alternatively, the surface of the hydrogel may not be parallel to the underside, so that a filling level of the hydrogel decreases from the higher opening to the lower opening.

The sacrificial structure may be applied in such a way that the openings are completely covered by the sacrificial structure. In the process, the sacrificial structure may also partially protrude into the canals. The sacrificial structure is also provided on the hydrogel, resulting in a structure that connects the openings. The structure formed in this way may be two-dimensional or three-dimensional.

The reservoir usually provides a maximum filling level. The hydrogel may be filled in the step of further filling the reservoir with hydrogel up to at most the maximum filling level, but also up to any other filling level between the height of one of the openings and the maximum filling level.

To rinse out the hydrogel, the temperature of the sample carrier and/or the substances filled into the substrate may be raised above a melting point of the sacrificial structure so that the sacrificial structure liquefies. Afterwards, the sacrificial structure can be flushed out through the channels. Water, for example, but also another suitable fluid may be used for this purpose. It is also possible to heat the fluid used for rinsing above the melting point of the sacrificial structure and guide it through the channels. This also gradually liquefies the sacrificial structure and it can eventually be rinsed out. Depending on the intended use and the temperature used for rinsing, different materials may be used for the sacrificial structure. For example, the sacrificial structure may include Pluronic. In this case, the rinsing can already be carried out at low temperatures, for example in the range between 4° C. and 8° C. Alternatively, the sacrificial structure may also contain gelatine. In this case, a higher temperature of 37° C. or higher should be used for rinsing, because gelatine becomes fluid at 37° C. or higher.

In the method described, the sacrificial structure may be applied by means of 3D printing.

On the one hand, the use of 3D printing to configure the sacrificial structure has the advantage that it can be automated. This is typically accompanied by good reproducibility and efficiency, for example in the form of time savings compared to other methods. On the other hand, 3D printing can also configure any structures with high precision. As can be seen from this description, the sample carrier is particularly compatible with the use of 3D printing.

The entire sacrificial structure can be printed this way. It is also possible to partially configure the sacrificial structure with 3D printing, for example at the openings or on the hydrogel.

In the described method for forming a channel structure in a hydrogel, a previously described sample carrier comprising a supply channel may first be provided, wherein further filling of the reservoir with hydrogel is performed through the supply channel and wherein rinsing of the sacrificial structure is not performed through the supply channel.

The method may further comprise closing the reservoir, for example using a closure element. As the reservoir is now closed, the hydrogel can no longer be filled into the reservoir from above. Instead, the supply channel may be used to fill the hydrogel into the reservoir. The additional layer of hydrogel may partially or completely enclose the sacrificial structure. The reservoir may be filled with hydrogel up to a maximum filling level of the reservoir or up to any filling level between the height of one of the openings and the maximum filling level. Finally, the sacrificial structure may be flushed out, wherein in this case the supply channel is not used to carry out the rinsing. The rinsing may be carried out as described in the method above.

By using a supply channel for filling hydrogel, especially in combination with a closure element, it is possible to fill the reservoir completely without hydrogel protruding or overflowing beyond the reservoir. In contrast, filling the reservoir from above with a filling device is less precise and/or it is more cumbersome to fill in the correct amount of hydrogel so that the reservoir is completely filled. If the amount of hydrogel is too small, unwanted cavities may build. If, on the other hand, the amount of hydrogel is too large, it may protrude beyond the reservoir and wet the surface of the sample carrier, which is also undesirable.

Closing may also be carried out after another method step. For example, the reservoir may also be closed after the hydrogel has been filled through the supply channel or after the sacrificial structure has been rinsed out.

In connection with this method, it is also possible as a further step to extract air bubbles in the hydrogel through the supply channel.

On the one hand, air bubbles in the hydrogel may cause the stability of the hydrogel to decrease and the channel structure formed in the hydrogel to become unstable and/or collapse. On the other hand, air bubbles adjacent to the channel structure may change this channel structure, for example by creating additional cavities in which a fluid guided through the channel structure can spread. This would falsify the investigations carried out and the resulting measurement results. Furthermore, air bubbles may induce aberration during microscopic examinations of the sample carrier.

The extraction of air bubbles may be combined in particular with a described sample carrier which is provided with a supply opening at a point in the side wall of the reservoir where an edge is formed and/or where the radius of curvature has a local minimum. In this case, air bubbles can be extracted particularly efficiently. This is due to the fact that the particularly small radius of curvature results in a funnel-like intake into the opening. As a result of a suction effect, air bubbles can be sucked into the supply opening in a particularly directed manner. In this case, for example, an evenly shaped side wall would be disadvantageous because there would be no directed suction effect. This would mean that large amounts of hydrogel would have to be extracted again in order to reliably extract the created air bubbles. In particular, a funnel-shaped intake may have the further advantage that the sample carrier can be tilted and the air bubbles rise into the intake as a result. They can be easily extracted there.

### FIGURES

Further features and advantages are explained below with reference to the exemplary figures, in which:

FIG. 1 shows a schematic oblique view of a sample carrier according to a first embodiment;

FIGS. 2A to 2D show different embodiments of the reservoir in the sample carrier and different embodiments of the surface area in the side wall of the reservoir;

FIG. 3A shows a schematic oblique view of a sample carrier according to a second embodiment;

FIG. 3B shows another view of the sample carrier in FIG. 3A;

FIGS. 4A and 4B show a schematic view of the sample carrier according to a third embodiment;

FIGS. 5A to 5C show different embodiments of a supply channel and/or of a supply opening;

FIGS. 6A to 6E show a method for forming a channel structure in a hydrogel according to a first embodiment; and

FIGS. 7A to 7D show a method for forming a channel structure in a hydrogel according to a second embodiment.

In the following and in the figures, the same reference signs are used for the same or corresponding elements in the various embodiment examples, unless specified otherwise.

### DETAILED DESCRIPTION

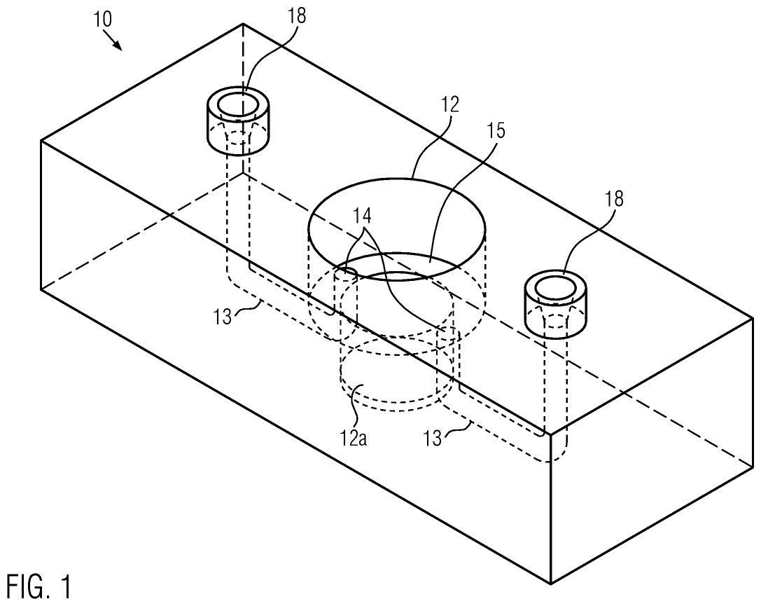

FIG. 1 shows the different elements of a sample carrier 10. Here, the sample carrier 10 is shown in an oblique view with its upper side in the foreground. In this case, the sample carrier 10 has the shape of a cuboid with a flat underside and comprises a transparent material, preferably one of the plastics COC, COP, PC, PS, PE, PMMA mentioned in this description or a transparent thermoplastic or an elastomer. The sample carrier 10 shown has a rectangular base corresponding to its underside. The base surface of the sample carrier 10 may in principle also have other shapes, for example otherwise polygonal shapes or shapes with rounded corners and/or edges.

A flat side is particularly advantageous for an optical examination. In microscopy, for example, a flat underside is needed to reduce or avoid aberration such as astigmatism.

In the upper side of the sample carrier 10, the reservoir 12 is formed in the shape of a cylindrical, i.e. circular in cross-section, recess in the sample carrier 10. However, as described below, the shape of the recess is not limited to a circular shape. The reservoir 12 is provided with a bottom 12a which is also provided in the sample carrier 10. This means that the underside of the sample carrier 10 is closed off. The bottom 12a is also in particular parallel to the underside of the sample carrier 10. On its side wall, the reservoir 12 is provided with a circumferential surface area 15 which has the form of a step. The surface of the step is therefore formed parallel to the bottom 12a of the reservoir 12 and the underside of the sample carrier 10.

The reservoir 12 may also be arranged in the form of a pot on the upper side of the sample carrier 10. In this case, the same considerations regarding the cross-sectional shape apply as in the case of a form of the reservoir 12 as a recess in the sample carrier 10.

Between the bottom 12a and the upper side of the sample carrier 10, the height of the reservoir 12 can be defined accordingly. As shown in the figure, the surface area 15 is provided approximately at half the height of the reservoir 12, so that the openings 14 are also provided approximately centrally between the bottom 12a and the upper side of the sample holder 10. However, the surface area 15 may also be provided at a different height in the reservoir 12. The specific embodiment may be adapted to the corresponding intended use of the sample carrier 10. In its intended use, the height of the surface area 15 will determine, for example, the position at which a channel structure will be formed in a hydrogel within the reservoir 12.

Furthermore, the sample carrier 10 comprises two channels 13, which are formed as cavities inside the sample carrier 10. The channels 13 are each provided with an opening 14 in the upper side of the step into the reservoir 12. Thus, the opening plane is parallel to the bottom 12a and the underside of the sample carrier 10. Starting from the opening 14, the channels 13 initially extend perpendicularly to the underside through the sample carrier 10. Below the opening 14, the channels continue horizontally through the sample carrier 10 before they again extend perpendicularly to an opening in the upper side of the sample carrier 10. The openings may be provided with a corresponding connector 18. Thus, the channels 13 extend between the opening 14 and the connector 18 within the sample carrier 10.

The connectors 18 shown in the figure are formed conically and conform in particular to the Luer standard. The connector 18 is a female Luer connector. When filling the channels 13 with an appropriate device, this facilitates a non leaking and efficient connection between the connectors 18 and a filling device. Accordingly, the filling device may be equipped with a male Luer or Luer lock adapter.

The specific selection of height, length and width of the sample carrier 10, as well as the shape, volume and specific embodiment of the reservoir 12 and the channels 13 are determined according to the corresponding use of the sample carrier 10. For example, a rectangular shape that mimics a typical slide used in microscopy may be useful in microscopic examination of the sample carrier 10. Shape and volume of the reservoir 12 may, for example, be optimised for the channel structure to be provided therein. Similarly, the sample carrier 10 is not limited to the two openings 14 and two channels 13 shown. There may also be more than two channels 13 and more than two openings 14. In particular, the number of channels 13 may also correspond to the number of openings 14 and connectors 18.

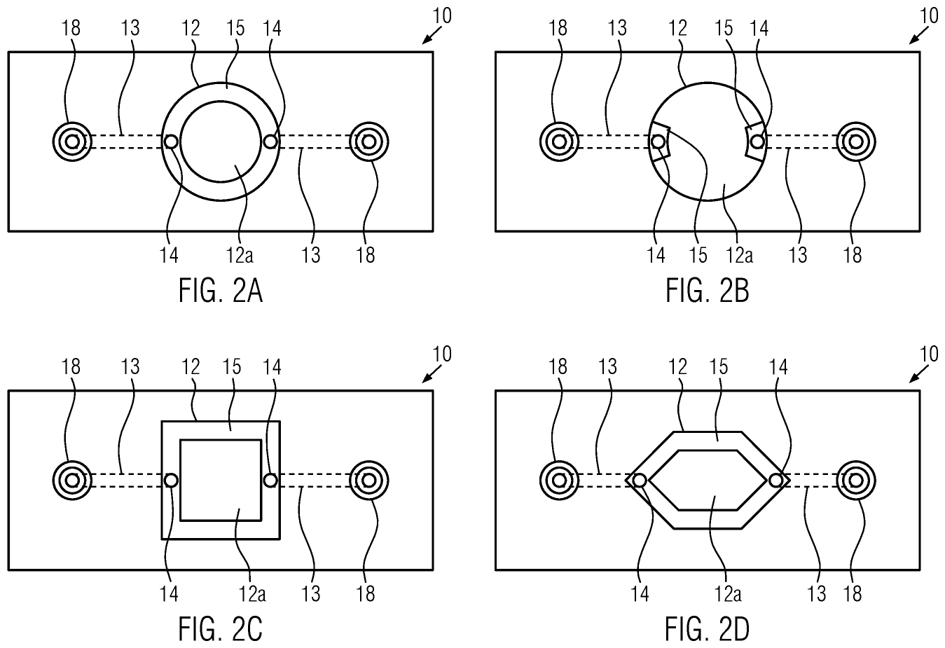

FIGS. 2A to 2D show a top view of different embodiments of a reservoir 12 provided in the sample carrier 10. In this case, the sample carrier 10 itself has a rectangular base; however the embodiments shown for the reservoir 12 may also be combined with other shapes of the sample carrier 10. In all of the examples shown, the reservoir 12 comprises a bottom 12a and a surface region 15 which has the form of a step. The upper side of the step is parallel to the bottom 12a. Furthermore, two openings 14 are provided in the upper side of the surface area 15, each of which represents one end of the channels 13. In principle, however, the embodiments of the reservoir 12 shown are not limited to two openings 14. Instead, more than two openings 14 may also be provided in the reservoir 12, in particular in the surface area 15.

In FIG. 2A, the base of the reservoir 12 is formed in a circular way and the surface area 15 is formed circumferentially on the side wall of the reservoir 12. The openings 14 are located at opposite points in the surface area 15.

In the example shown in FIG. 2B, the base of the reservoir 12 is formed in a circular way. The surface area 15 is provided on the side wall of the reservoir 12 at only two separate sections and an opening is provided in each of the two separate sections of the surface area 15. In the example shown, the two sections are located on opposite sides of the inner wall of the reservoir 12. However, it is also possible to choose any arrangement of the sections on the side wall. It is also possible to have one, two or more separate sections. There may be a separate section for each opening 14. Similarly, more than one opening 14 may be provided in a single section. There may also be sections where no opening 14 is provided.

In addition to a circular base, the reservoir 12 may, for example, have an elliptical base.

The reservoir 12 of the embodiment shown in FIG. 2C has a rectangular base. The surface area 15 is formed circumferentially on the side wall of the reservoir 12. The openings 14 are located at opposite points in the surface of the surface area 15.

While FIG. 2C shows a rectangular base of the reservoir 12, other quadrangular shapes are also conceivable. This includes, in particular, a square, a rhombus, a parallelogram, a trapezoid or even irregular quadrangles as a base shape.

The reservoir shown in FIG. 2D has a hexagonal base with a surface area 15 formed circumferentially on the side wall of the reservoir 12. The openings 14 are located at opposite points in the surface area 15.

The examples shown in FIGS. 2A to 2D are not limited to these specific combinations. Thus, the shape of the base of the reservoir 12 may be freely combined with the configuration of the surface area 15 and the arrangement of the openings 14 in the surface area 15. For example, a rectangular or hexagonal reservoir 12 may be provided with separate sections of a surface area 15. Also, the openings 14 do not necessarily have to be disposed at opposite points of the reservoir 12.

In addition to the reservoir 12, the channels 13 and connectors 18 are also shown in FIGS. 2A to 2D. However, the specific arrangement and number of channels 13 and connectors 18 with respect to the reservoir 12 are not limited to the examples shown.

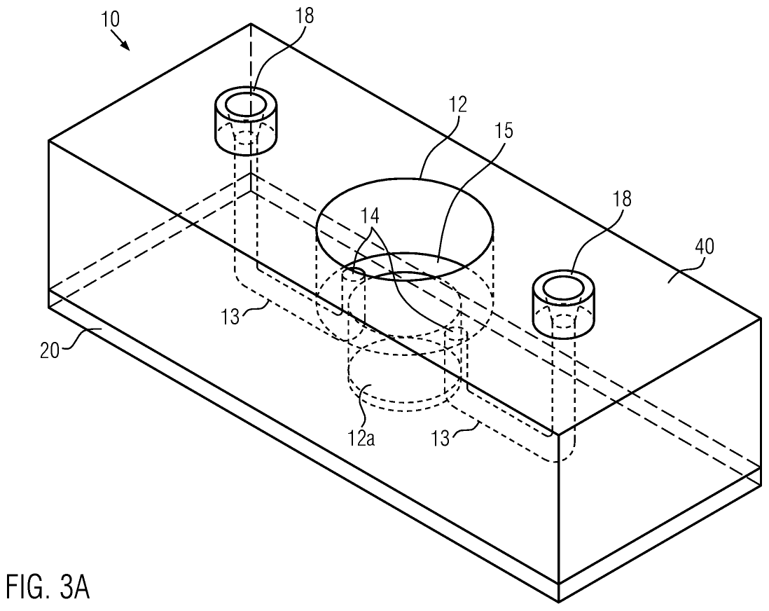

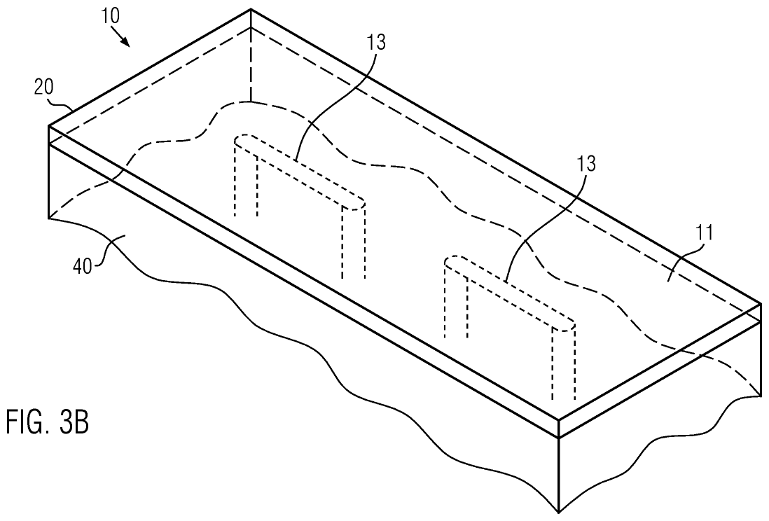

FIG. 3A shows an oblique view of a sample carrier 10. The sample carrier 10 comprises a bottom element 20 and a cover element 40. The other elements of the sample carrier 10 shown correspond to those of the exemplary embodiment according to FIG. 1.

In this embodiment, the configuration of the channels 13 in the sample carrier 10 may differ from the exemplary embodiment according to FIG. 1, so that the channels 13 are not completely formed as a cavity within the sample carrier 10. Instead, the channels 13 may be at least partially formed as trenches or groove-like recesses on a surface of the cover element 40. This configuration is shown in FIG. 3B. The figure shows an oblique view of a sample carrier 10, with its underside 11 shown above. The two channels 13 each comprise a section in which they are formed in the shape of trenches in the surface of the cover element 40. The channels 13 do not have to be formed as a trench over their entire length. As shown in the example, the channels 13 extend from the trenches, for example, vertically through the sample carrier 10.

The trenches are covered with the bottom element 20. In particular, the bottom element 20 may be a transparent film, in particular made of the aforementioned materials COC, COP, PC, PS, PE, PMMA or another transparent plastic or a thermoplastic. In particular, this film can exhibit the autofluorescence and birefringence of a Schott cover glass. The trenches are covered in such a way that any fluid flowing through the channels 13 cannot escape at the trenches. The cover with the bottom element 20 is therefore non leaking.

The figure shows two channels 13 which are partially formed as trenches in the surface of the sample carrier 10. However, this example is not to be construed as limiting. As described, a sample carrier 10 may also comprise more than two channels 13. Accordingly, none, one, several or all of the channels may be at least partially formed as trenches on a surface of the cover element 40.

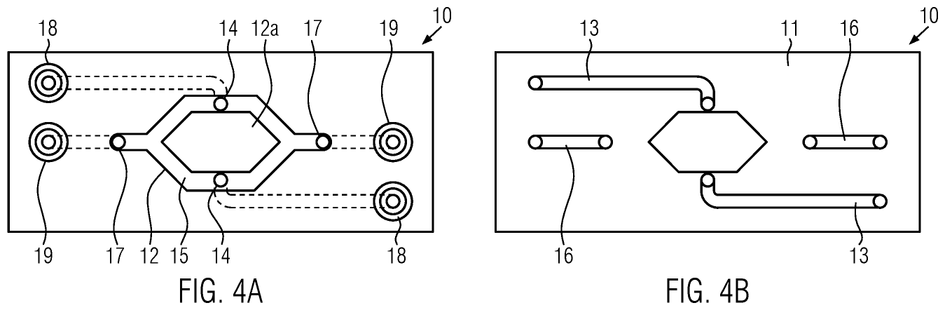

FIGS. 4A and 4B each show a top view of a sample carrier 10.

FIG. 4A shows a top view of a sample carrier 10, showing the upper side of the sample carrier 10. This comprises a reservoir 12 with a base 12a. The reservoir 12 has a hexagonal base with an extension at two opposite corners. The bottom 12a has the shape of a hexagon. On the side wall of the reservoir 12, the surface area 15 is formed circumferentially, on the upper side of which two openings 14 are arranged. In this case, these openings 14 are located on opposite sides of the reservoir 12. A total of four connectors are provided on the upper side of the sample carrier 10. Of these, two connectors 18 belong to channels 13 which lead from these connectors 18 to the openings 14. In addition, two further connectors, so-called supply connectors 19, are provided, the purpose of which is explained below.

FIG. 4B shows a top view of the same sample carrier 10 as in FIG. 4A, wherein the underside 11 of the sample carrier is shown. Two channels 13 and two further supply channels 16 can be seen. These four channels shown are formed as trenches on the underside 11 of the sample carrier 10. However, it is also possible that one, more or all of the supply channels 16 and channels 13 shown are also formed as a cavity within the sample carrier 10. The number of channels 13 and supply channels 16 is also not limited to two each. Thus, more than two channels 13 and/or one, two or more than two supply channels 16 may also be provided.

The supply connectors 19 thus correspond to the connectors of the supply channels 16 on the upper side of the sample carrier 10.

FIG. 4A also shows two supply openings 17 disposed in the surface area 15 of the reservoir 12. These supply openings 17 each form one end of a supply channel 16 that opens into the reservoir 12. The supply opening 17 is therefore connected to the supply connector 19 via the supply channel 16. As shown in the figure, the reservoir 12, which in this case has a hexagonal base, includes a narrow extension at two opposite corners. Specifically, this narrow extension is formed in such a way that the upper side of the surface area 15 is formed as an extension of one of the corners of the reservoir 12.

The arrangement of the supply openings 17 is not limited to the example shown. In particular, the supply openings 17 do not have to be located at opposite corners or edges of the reservoir 12.

Narrow in this context means that the extension has a smaller width than length.

Such a configuration of a supply opening 17 at a point with a minimum radius of curvature or an edge offers the practical advantage in the intended use of the sample carrier 10 that air bubbles which may be formed in a hydrogel within the reservoir can be more easily extracted. This would not be the case if a supply opening 17 was disposed in a more open position, for example in a flat surface as in the case of the openings 14.

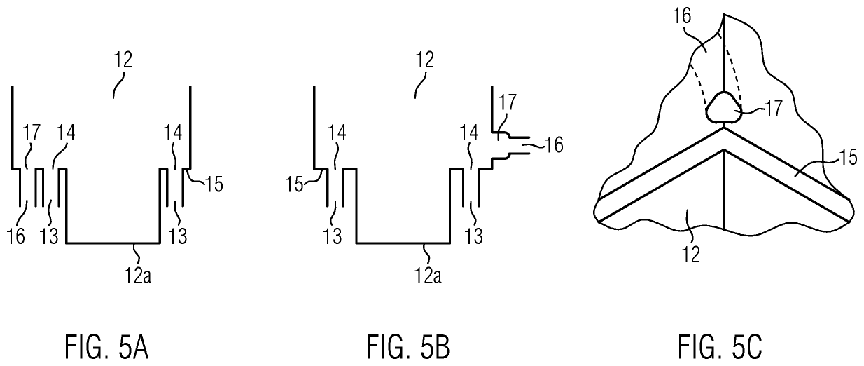

FIGS. 5A to 5C show further exemplary embodiments for the arrangement of a supply opening 17 in the reservoir 12.

FIG. 5A shows a cross-section of a reservoir 12 with a bottom 12a in which two openings 14, each forming one end of a channel 13, are provided in the upper side of a surface area 15. In addition, a supply opening 17 is provided in the upper side of the surface area 15, forming one end of a supply channel 16 and located adjacent to one of the openings 14. This configuration is similar to that shown in FIG. 4A, in which the supply openings 17 are provided in a narrow extension of the reservoir. In particular, the supply opening 17 may be disposed in the immediate vicinity of a vertical section of the side wall so that the supply opening 17 is adjacent to an edge. In particular, the example shown is not limited to one supply opening 17, so that more than one supply opening 17 may also be provided.

FIG. 5B shows another possible arrangement of a supply opening 17 in a reservoir 12. Unlike in the previous embodiment, the supply opening 17 is here disposed in a vertical section of the side wall of the reservoir 12 and above the surface area 15. In addition, the supply opening 17 has the form of a recess in the side wall, at the end of which the supply channel 16 is arranged. The diameter of the supply opening 17 is larger than the diameter of the supply channel 16 at the transition to the supply opening 17. In particular, the recess may have a tapered form, for example in the shape of a hemisphere, a truncated pyramid or a truncated cone. Other embodiments that meet this criterion are also conceivable at this point.

Another arrangement of a supply opening 17 within the reservoir 12 is shown in FIG. 5C. The figure shows an oblique view of an edge of the reservoir 12. The supply opening 17 is provided directly in the edge and above the surface area 15. In this case, the supply channel 16 connects directly to the supply opening 17 and has the same diameter as the supply opening 17.

The aforementioned embodiments of a supply opening 17 within the reservoir 12 are not limited to the aforementioned possibilities and may in particular be combined with one another. For example, there may be several supply openings 17 in the reservoir 12. In this case, several of the mentioned combinations may be realised at the same time, i.e. the several supply openings 17 may be arranged in different ways. It is also possible to use a form of a recess as shown in FIG. 5B.

In all the cases shown, the desired technical effect of being able to more easily extract air bubbles in a hydrogel is achieved.

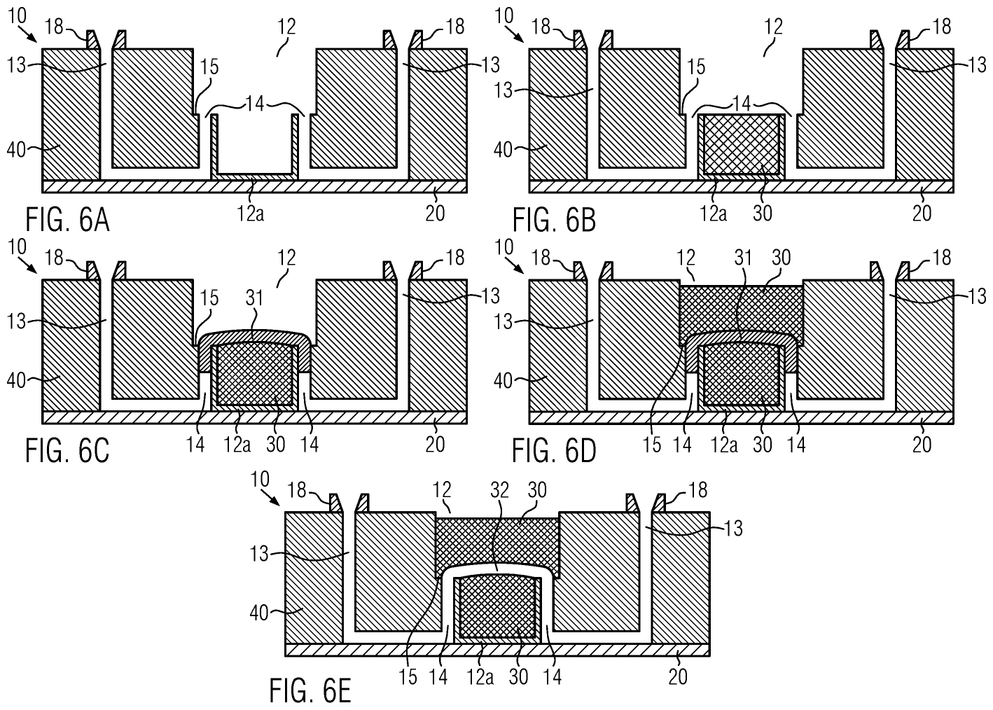

FIGS. 6A to 6E show the steps of a method according to the invention for forming a channel structure in a hydrogel using a sample carrier according to the present invention.

FIG. 6A shows a sample carrier 10 as shown in FIG. 3. However, the method described below is not limited to this embodiment of a sample carrier 10, but may also be carried out, for example, with a sample carrier 10 as shown in FIGS. 1 and 2 or with a sample carrier as shown in FIGS. 4 and 5 in an exemplary way.

The sample carrier 10 is shown in cross-section along the central longitudinal axis and, according to the invention, comprises a cover element 40 with a reservoir 12 with a bottom 12a, with a surface area 15 formed as a step and two openings 14, two channels 13 with conical connectors 18, and a bottom element 20. The sample carrier 10, in particular the reservoir 12, is not filled at the beginning of the method.

The channels 13 extend from the openings 14 in the reservoir 12 perpendicularly to the underside of the sample carrier 10 through the cover element 40 to the lower side of the cover element 40.

On the lower side of the cover element 40, a trench is provided parallel to the underside of the sample carrier 10. At one end of the trench, a further section of the channel 13 is connected which extends perpendicularly to the underside of the sample carrier 10 through the cover element and ends in a opening at the upper side of the sample carrier 10 which is provided with a connector 18.

In a first method step according to FIG. 6B, the reservoir 12 is filled with a hydrogel 30, wherein the reservoir 12 is only filled to a height such that the openings 14 are not covered with the hydrogel 30. In particular, no hydrogel should penetrate into the channels 13 and block them. In this example, the two openings 14 are arranged at the same height up to which the hydrogel 30 is also filled. The two openings 14 may also be arranged at different heights. In this case, the hydrogel 30 may be filled, for example, up to the height of the lower opening 14, or the filling level of the hydrogel 30 decreases from the upper opening 14 towards the lower opening 14.

It should be noted that, for example due to the manufacturing process, the level of the hydrogel 30 in the reservoir 12 may be greater in the region of the side wall of the reservoir 12 than in regions spaced from the side wall, for example due to the formation of a meniscus on the side wall of the reservoir 12.

The hydrogel 30 may be filled into the reservoir 12 from above, for example with a filling device provided for this purpose or manually.

The next method step is shown in FIG. 6C, in which a sacrificial structure 31 is introduced into the reservoir 12. The sacrificial structure 31 is applied to the hydrogel 30 in the shape in which the later channel structure 32 is to be formed in the hydrogel 30. This structure may include, in particular, branching and merging of individual channels. It is also possible to arrange the channel structure 32 not only in one plane, but three-dimensionally. When the sacrificial structure 31 is applied to the hydrogel 30, it is important that the sacrificial structure 31 does not run but maintains a firm consistency. Accordingly, the material used for the sacrificial structure 31 is, for example, Pluronic or gelatin. Other materials are also conceivable as long as they meet the requirements mentioned above.

The sacrificial structure 31 is also applied to the openings 14, wherein, in particular, it is possible that the sacrificial structure 31 partially penetrates the channels 13. In this way, it can be achieved that a continuous sacrificial structure 31 is created between the two openings 14 and that no hydrogel 30 can penetrate into the channels 13. This step is crucial for the eventual formation of a non-leaking and fillable channel structure 32.

The application of the sacrificial structure 31 may be carried out in particular with a 3D printer. For this purpose, the needle of the 3D printer is inserted into the reservoir 12 from above and the sacrificial structure 31 is printed accordingly onto the openings 14 and the hydrogel 30. Due to the upward facing, in particular perpendicular, configuration of the openings 14, the needle of the 3D printer can protrude into the channels 13 and apply the sacrificial structure 31. This prevents hydrogel from penetrating the channels 13 and blocking them in further carrying out the method.

It additionally ensures that a coherent sacrificial structure 31 and, at the end, a coherent channel structure 32 can be produced between the two openings 14. Another advantage of using a 3D printer is a precise or detailed and reproducible forming of a sacrificial structure 31 and thus a channel structure 32 in the hydrogel 30.

As shown in FIG. 6D, a further layer of hydrogel 30 is filled in the subsequent method step. In this step, the sacrificial structure 31 is embedded in the hydrogel 30 or completely covered with hydrogel 30. The fact that the sacrificial structure 31 has previously been applied on the openings 14 and at least partially into the channels 13 means that no hydrogel 30 enters the channels 13, preventing them from becoming blocked.

The second layer of hydrogel 30 may be filled to such an extent that the reservoir 12 is completely filled. This corresponds to a maximum filling level. However, this is not necessarily the case. It is also possible that only enough hydrogel 30 is filled in this step so that the sacrificial structure 31 is embedded or just covered. Another filling level between the two possibilities mentioned is also conceivable.

The final step of the method, in which the sacrificial structure 31 is rinsed out, is shown in FIG. 6E. For this purpose, the temperature of the sample carrier 10 and/or the substances filled in the reservoir 12 may first be raised above the melting point of the sacrificial structure 31. This liquefies the sacrificial structure 31. A fluid is introduced via the channels 13 to rinse out the sacrificial structure 31, so that the liquefied sacrificial structure 31 is rinsed out. Depending on the choice of material of the sacrificial structure 31, for example, water or another suitable fluid may be used for rinsing in this step.

Likewise, the fluid guided through the channels 13 may have a temperature above the melting point of the sacrificial structure 31, so that the sacrificial structure 31 gradually liquefies and can be flushed out of the hydrogel 30 in this way. Heating the entire sample carrier 10 would not be necessary in this case.

Thus, after this method step a channel structure 32 remains in the hydrogel 30 at the points where the hydrogel 31 was previously formed. This channel structure 32 is contacted at the openings 14 and together with the channels 13 forms a closed fluid path. Carriers, cells or cell media, for example, may now be introduced into the channel structure 32 via the channels 13.

In this context, it should be mentioned that the hydrogel 30 must be sufficiently stable so that the channel structure 32 remains after the sacrificial structure 31 has been rinsed out. Likewise, the hydrogel 30 must not be removed during rinsing. For these reasons, the materials mentioned in this description are suitable for the hydrogel 30, wherein the hydrogel 30 has been gelled accordingly.

The described method may be carried out together with all embodiments of a sample carrier 10 included in this description and is in particular not limited to a specific embodiment of a sample carrier 10.

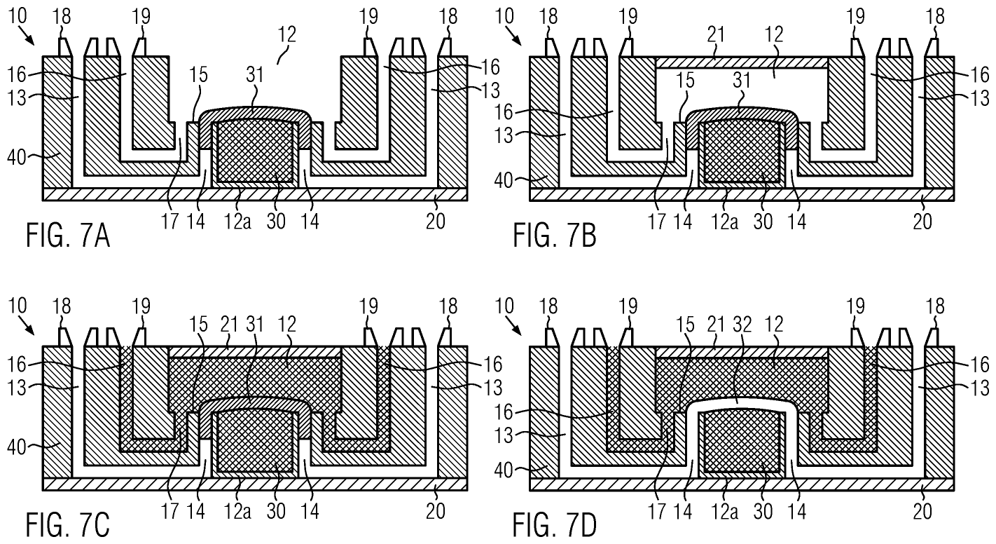

FIGS. 7A to 7D show the steps of a method for forming a channel structure in a hydrogel.

For this purpose, a sample carrier 10 is first provided. This comprises a cover member 40 having a reservoir 12 with a bottom 12a, two openings 14 with a surface area 15 formed as a step, two channels 13, two supply channels 16 each having an end opening into the reservoir 12 as a supply opening 17. These supply openings 17 are provided in the same way as the openings 14 in the surface area 15 and face vertically upwards. Two connectors 18 for each of the channels 13 and two supply connectors 19 for the supply channels 16 are arranged on the upper side of the sample carrier 10. The underside of the sample carrier 10 is formed by a bottom element 20. The sample carrier 10, in particular the reservoir 12, is not filled at the beginning of the method.

The supply channels 16 extend from the supply opening 17 in the reservoir perpendicularly to the underside of the sample carrier 10 through the cover element 40 to the lower side of the cover element 40. On the lower side of the cover element 40, a trench is disposed parallel to the underside of the sample carrier 10. At one end of the trench a further section of the supply channel 16 is connected which extends perpendicularly to the underside of the sample carrier 10 through the cover element 40 and ends in a opening at the upper side of the sample carrier 10 which is provided with a supply connector 19.

The first two method steps, i.e. filling a hydrogel 30 and applying a sacrificial structure 31, are analogous to those in the first exemplary embodiment of the method for forming a channel structure 32 in a hydrogel 30.

As shown in FIG. 7B, the next step consists in closing the reservoir with a closure element 21. This closure element 21 may be arranged flush with the upper side of the sample carrier as shown. It is also possible to arrange the closure element 21 within the reservoir 12, for example at a height between the surface area 15 and the upper side of the sample carrier 10. In particular, the closure element 21 may comprise the same material as the bottom element 20 and, in particular, have the same thickness.

After the reservoir 12 has been covered, another layer of hydrogel 30 is introduced in the reservoir 12. This step is shown in FIG. 7C. Since the second layer of hydrogel 30 cannot be introduced into the reservoir 12 from above after the reservoir 12 has been covered, the hydrogel 30 is introduced via at least one of the supply channels 16. For this purpose, the hydrogel 30 is guided from the supply opening 19 through the supply channel 16 into the reservoir 12.

The reservoir 12 may be completely filled with hydrogel 30 up to the closure element 21. Alternatively, only enough hydrogel 30 may be filled in this step to embed or just cover the sacrificial structure 31. Likewise, any other filling level between the two possibilities mentioned is conceivable.

As shown in the figure, the supply channels 16 may also be filled with hydrogel 30 after this method step, which does not represent a disadvantage for the intended use of the sample carrier 10. Instead, the supply channel 16 may also be cleared of hydrogel 30 after the reservoir 12 has been filled. For example, it is possible to direct air through the supply connector 19 into the supply channel 16 so that the hydrogel remaining in the supply channel 16 is still guided into the reservoir 12, but without creating air bubbles in the hydrogel.

In a final step as shown in FIG. 7D, the sacrificial structure 31 is rinsed out. This method step is analogous to the corresponding method step of the method for forming a channel structure 32 in a hydrogel 30 according to the method illustrated in FIGS. 6A to 6E. Again, the same requirements apply to the hydrogel 30 and the sacrificial structure 31, for example in terms of stability, as in the previous exemplary embodiment of the method.

1. A sample carrier (10), comprising
a reservoir (12) with a bottom (12a); and
two channels (13), each having an opening (14) into the reservoir (12),
wherein the two openings (14) are arranged above the bottom (12a),
wherein an underside (11) of the sample carrier (10) is formed flat, and
wherein each of the two openings (14) faces in a direction that is not parallel to the underside (11).

2. The sample carrier (10) according to claim 1, wherein the reservoir (12) has a side wall
comprising a surface region (15) that is not perpendicular to the underside (11), wherein one opening (14) or both openings (14) are arranged in the surface region (15).

3. The sample carrier according to claim 2:
wherein the surface region (15) is configured in the form of a step, and
wherein the surface region (15) is provided parallel to the underside (11).

4. The sample carrier (10) according to claim 1, wherein a second end of one of the two channels is configured in the form of a hole on an upper surface of the sample carrier (10), which is arranged opposite to the underside (11).

5. The sample carrier (10) according to claim 1, comprising
a cover element (40), and
a bottom element (20),
wherein the cover element (40) and the bottom element (20) are connected to each other over the complete area,
wherein the underside (11) of the sample carrier (10) is configured on the bottom element (20),
wherein at least one of the channels (13) is at least partially configured in the form of a trench on one side of the cover element (40), and
wherein the trench is covered by the bottom element (20).

6. The sample carrier (10) according to claim 1, wherein one channel (13) or both channels (13) extend from the openings (14) at least partially perpendicularly to the underside (11) through the sample carrier (10).

7. The sample carrier (10) according to claim 1, further comprising
a supply channel (16),
wherein one end of the supply channel (16) opens into the reservoir (12) in a supply opening (17), and
wherein the supply opening (17) is arranged at a level of one of the two openings (14) or above both openings (14).

8. The sample carrier (10) according to claim 7, wherein the supply opening (17) is arranged at a point in the side wall of the reservoir (12) at which an edge is present and/or at which a radius of curvature of the side wall has a local minimum.

9. The sample carrier (10) according to claim 1, further comprising a closing element (21) that closes the reservoir (12) to the outside.

10. The sample carrier (10) according to claim 1:
wherein the reservoir (12) is filled with a hydrogel (30), and
wherein the openings (14) are not covered with the hydrogel (30).

11. The sample carrier (10) according to claim 10:
wherein a channel structure (32) is formed in the hydrogel (30), and
wherein the channel structure (32) connects the openings (14).

12. A method for forming a channel structure (32) in a hydrogel (30) comprising:
providing a sample carrier (10) according to claim 1;
filling the reservoir (12) of the sample carrier (10) with the hydrogel (30) so that the openings (14) are not covered with the hydrogel (30);
applying a sacrificial structure (31) onto the filled hydrogel (30) so that the openings (14) are completely covered by the sacrificial structure (31) and the openings (14) are connected by the sacrificial structure (31);
further filling the reservoir (12) with hydrogel (30) so that the sacrificial structure (31) is partially or completely enclosed by the hydrogel (30); and
rinsing out the sacrificial structure (31) so that the channel structure (32) connecting the openings (14) forms in the hydrogel (30).

13. The method according to claim 12, wherein the sacrificial structure (31) is applied by means of 3D printing.

14. The method according to claim 12,
wherein the filling of the reservoir (12) of the sample carrier (10) with further hydrogel (30) is performed through a supply channel (16), and
wherein the rinsing out of the sacrificial structure (31) is not carried out via the supply channel (16).

15. The method according to claim 14 further comprising:
extracting air bubbles in the hydrogel (30) through the supply channel (16).
